(19) United States
(12) Patent Application Publication
(10) Pub. No.: US 2006/0093031 A1
(43) Pub. Date: May 4, 2006

(54) Method and apparatus for performing multiple description motion compensation using hybrid predictive codes

(75) Inventors: Mihaela Van Der Schaar, Ossining, NY (US); Deepak Turaga, San Jose, CA (US)

Correspondence Address: PHILIPS INTELLECTUAL PROPERTY & STANDARDS, P.O. BOX 3001, BRIARCLIFF MANOR, NY, 10510, US

(73) Assignee: koninkijke phillips electronics n.v.

(21) Appl. No.: 10/523,434

(22) PCT Filed: Jul. 24, 2003
(86) PCT No.: PCT/IB03/03436

§ 371 Date: Jan. 28, 2005

(30) Foreign Application Priority Data
Jul. 31, 2002 (US) 60339755
Apr. 10, 2003 (US) 60461780

(51) Int. Cl. H04N 11/04; H04N 11/02; H04N 7/12; H04B 1/66

(52) U.S. Cl. 375/240.01

(57) ABSTRACT

An improved multiple description coding (MDC) method and apparatus is provided which extends multi-description motion compensation (MDMC) by allowing for multi-frame prediction and is not limited to only I and P frames. Further, the coding method of the invention extends MDMC for use with any conventional predictive codec, such as, for example, MPEG2/4 and H.26L. The improved MDC permits the use of any conventional predictive coder for use as a top and bottom predictive encoder. Further, the top and bottom predictive coders can advantageously include B-frames and multiple prediction motion compensation. Still further, any of the top, middle and bottom predictive encoders can be a scalable encoder (e.g., FGS-like or data-partitioning like where the motion vectors (MVs) are sent first, temporal scalability etc.).

The present invention relates generally to multiple description coding (MDC) of data, speech, audio, images, video and other types of signals for transmission over a network or other type of communication medium.

A large fraction of the information that flows across today's networks is useful even in a degraded condition. Examples include speech, audio, still images and video. When this information is subject to packet losses, retransmission may be impossible due to real-time constraints. Superior performance with respect to total transmitted rate, distortion, and delay may sometimes be achieved by adding redundancy to the bit stream rather than repeating lost packets.

Redundancy may be added to a bit stream in one way through multiple description coding (MDC) wherein the data is broken into several streams with some redundancy among the streams. When all the streams are received, one can guarantee low distortion at the expense of having a slightly higher bit rate than a system designed purely for compression. On the other hand, when only some of the streams are received, the quality of the reconstruction degrades gracefully, which is very unlikely to happen with a system designed purely for compression. Unlike multi resolution or layered source coding, there is no hierarchy of descriptions; thus multiple description coding is suitable for erasure channels or packet networks without priority provisions.

Multiple description coding can be implemented in a number of ways. One way is by splitting an incoming video stream into an arbitrary subset of channels by collecting the odd and even frame sequence separately at the encoder and coding the resultant temporally sub-sampled sequences independently. Upon receiving one of the sub-sampled sequences at the decoder, the video stream can be decoded at half the frame rate. Due to the correlated nature of the video stream, receiving only one of the sub-sampled sequences allows for the recovery of intermediate frames using motion compensated error concealment techniques. This technique is described in greater detail in Wenger et al., “Error resilience support in H.263+,”, IEEE Transactions on Circuits and Systems for Video Technology, pp. 867-877, November 1998.

To achieve error resilience, Wang and Lin, “Error resilient video coding using multiple description motion compensation,” IEEE Trans. Circuits and Systems for Video Technology, vol. 12, no. 6, pp. 4348-52, June 2002, describe one method for implementing multiple description coding. In accordance with this approach, temporal predictors allow the encoder to use both the past even and odd frames while encoding, thus creating a mismatch between the encoder and the decoder when only one description is received at the decoder. The mismatch error is explicitly encoded to overcome this problem. The main benefit of allowing the encoder to use both odd and even frame sequence for prediction is in terms of coding efficiency. By changing the temporal filter taps, the amount of redundancy can be controlled. The method disclosed provides reasonable flexibility between the amount of redundancy and the error resilience.

A drawback of the approach of Wang and Lin is that it is limited to only I and P frames (no B-frames). A further drawback of the approach is that it does not allow for multi-frame prediction like that employed in H.26L. These drawbacks limit the coding efficiency of MDMC and also require full proprietary implementations instead of using available codes modules.

The invention provides an improved multiple description coding (MDC) method and apparatus which overcomes the drawbacks described above. Specifically, the coding method of the invention extends multi-description motion compensation (MDMC) by allowing for multi-frame prediction and is not limited to only I and P frames. Further, the coding method of the invention extends MDMC for use with any conventional predictive codec, such as, for example, MPEG2/4 and H.26L.

According to a first aspect of the invention, there is provided an improved MDMC encoder including three predictive coders, i.e., a top, middle and bottom coder. Input frames are supplied to the encoder as three separate inputs. The input frames are supplied to a central encoder. In addition, the input frames are divided or split into two sub-streams of frames, a first sub-stream comprising only the odd frames and a second sub-stream comprising only the even frames. The first sub-stream comprised of odd frames is provided as input to be encoded by the top encoder to yield an encoded odd frame sequence and the second sub-stream comprised of even frames is provided as input to be encoded by the bottom encoder to yield an encoded even frame sequence. It is noted that other embodiments may divide the frames using different criteria such as, for example, an unbalanced division where every two of three frames is encoded by the top encoder and every third frame is encoded by the bottom encoder. The original undivided input stream of frames is applied to the central encoder which computes the prediction of the odd frames from the even frames. Additionally, the central encoder separately computes the prediction of the even frames from the odd frames. Prediction residuals are then computed between the central encoder and the first and second side encoders, respectively. The MDMC encoder of the invention outputs the first computed prediction residual, corresponding to the prediction of the even frames, along with the output of the top encoder and outputs the second computed prediction residual, corresponding to the prediction of the odd frames, along with the output of the bottom encoder.

According to a second aspect of the invention there is provided a method of encoding a video signal representing a sequence of frames, the method comprising splitting the sequence of frames into a first sub-sequence and a second sub-sequence, applying the first sub-sequence to a first side encoder, applying the second sub-sequence to a second side encoder, applying the original unsplit sequence of frames to a central encoder, computing a first prediction residual between the output of the first side encoder and the central encoder, computing a second prediction residual between the output of the second side encoder and the central encoder, combining the first prediction residual and the output of the first side encoder as a first data sub-stream, combining the second prediction residual and the output of the second side encoder as a second data sub-stream, separately transmitting the first and second data sub-streams.

Advantages of the invention include:

(1) Any conventional predictive coder may be used for the top and bottom encoders. Further, the top and bottom predictive coders can advantageously include B-frames and multiple prediction motion compensation

(2) Any of the top, middle and bottom predictive encoders can be a scalable encoder (e.g., FGS-like or data-partitioning like where the motion vectors (MVs) are sent first, temporal scalability etc.). For example, in the case where only the middle encoder is a scalable encoder, the middle encoder will send only as much information as the channel allows. In an extreme case when it is determined that the available bandwidth is very low, only the information encoded by the side-coders will be transmitted. As additional bandwidth becomes available, then as much of the mismatch signal as the channel allows will be transmitted using the scalable middle encoder.

(3) To limit the complexity of the system, the prediction from odd/even frame sequence of the current even/odd frame for determining the mismatch signal can be made from B-frames.

(4) Instead of computing and coding the side prediction errors ((i.e., the errors between the even-frames and odd-frames for the side coders) as is conventional and also the mismatch between the side prediction error and the central error (i.e., the error between the current-frame and the prediction from the previous two frames), alternatively, the central error is computed.

Referring now to the drawings where like reference numbers represent corresponding parts throughout:

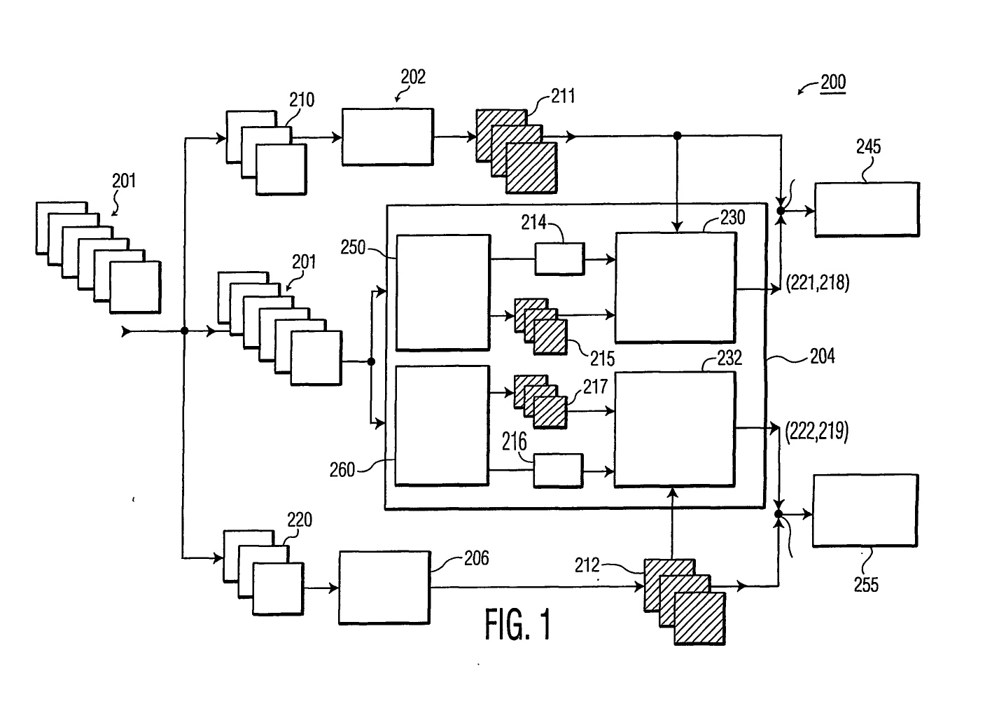

FIG. 1 illustrates an MDMC encoder according to one embodiment of the invention.

Multiple Description Coding (MDC) refers to one form of compression where the goal is to code an incoming signal into a number of separate bit-streams, where the multiple bit-streams are often referred to as multiple descriptions. These separate bit-streams have the property that they are all independently decodable from one another. Specifically if a decoder receives any single bit-stream it can decode that bit-stream to produce a usefull signal (without requiring access to any of the other bit-streams). MDC has the additional property that the quality of the decoded signal improves as more bit-streams are accurately received. For example, assume that a video is coded with MDC into a total of N streams. As long as a decoder receives any one of these N streams it can decode a useful version of the video. If the decoder receives two streams it can decode an improved version of the video as compared to the case of only receiving one of the streams. This improvement in quality continues until the receiver receives all N of the streams, in which case it can reconstruct the maximum quality.

There are a number of different approaches to achieve MDC coding of video. One approach is to independently code different frames into different streams. For example, each frame of a video sequence may be coded as a single frame (independently of the other frames) using only intra frame coding, e.g. JPEG, JPEG-2000, or any of the video coding standards (e.g. MPEG-1/2/4, H.26-1/3) using only I-frame encoding. Then different frames can be sent in the different streams. For example, all the even frame sequence may be sent in stream 1 and all the odd frames may be sent in stream 2. Because each of the frames is independently decodable from the other frames, each of the bit-streams is also independently decodable from the other bit-stream. This simple form of MDC video coding has the properties described above, but it is not very efficient in terms of compression because of the lack of inter-frame coding.

Before describing FIG. 1 in detail, we recall some definitions concerning the hierarchical arrangement of the pixels within a digitized picture and the prediction strategy as used in MPEG2 standard. Both luminance and chrominance samples (pixels) are grouped into blocks each made of an 8.times.8 matrix (8 rows of 8 pixels each); a certain number of luminance and chrominance blocks (e. g. 4 blocks of luminance data and 2 corresponding blocks of chrominance data) form a macro-block; the digitised picture then comprises a matrix of macro-blocks of which the size depends on the profile (i. e. on the resolution) chosen and on the power supply frequency: for instance, in case of 50 Hz power supply, the size can range from a minimum of 18.times.32 macro-blocks to a maximum of 72.times.120. Pictures can in turn have a frame structure (in which pixels of subsequent rows pertain to different fields) or a field structure (in which all pixels pertain to the same field). As a consequence, macro-blocks may have a frame or field structure, as well. Pictures are in turn organized into groups of pictures, in which the first picture is always an I picture, which is followed by a number of B pictures (bi-directionally interpolated pictures, which have been submitted to forward or backward prediction or to both, ‘forward’ meaning that prediction is based on a previous reference picture and ‘backward’ meaning that prediction is based on a future reference picture) and then by a P picture which, being used for prediction of the B pictures, is to be encoded immediately after the I picture.

Referring now to FIG. 1, a source, not shown, supplies the encoder 200 with a sequence of frames 201 (i.e., a frame structure) already arranged in the coding order, i. e. an order making the reference pictures available before the pictures utilizing them for prediction. The full frame sequence 201 is received by a motion estimation unit (not shown) which is to compute and emit one or more motion vectors for each macro-block in a picture being coded, and a cost or error associated with the or each vector. The encoder 200 includes a first side encoder (side encoder 1) 202, a central encoder 204 and a second side encoder 206. The full frame sequence 201 is applied in its entirety to the central encoder 204. A first subset 210 of the full frame sequence 201, which in the present embodiment constitutes the even frame sequence 210 subset of the full frame sequence 201, is applied to the first side encoder 202. A second subset 220 of the full frame sequence 201, which in the present embodiment constitutes the odd frame sequence 220 of the full frame sequence 201, is applied to the second side encoder 206.

The prediction encoding operation will now be summarized.

A. First Side Encoder 202

Odd frame sub-sequence 210, which comprises a subset of input sequence 201, is applied to the first side encoder 202. It should be noted that the first side encoder 202 may be advantageously embodied as any conventional predictive codec (e.g., MPEG-1/2/4, H.26-1/3). The odd frame sub-sequence 210 is encoded by the first side encoder 202 which outputs encoded odd frame sub-sequence 211. Encoded odd frame sub-sequence 211 is included as one component to be output in the first data sub-stream 245. The encoded odd frame sub-sequence 211 is also supplied as an input to central encoder sub-module 230, to be described below.

B. Second Side Encoder 206

Even frame sub-sequence 220, which comprises a subset of input sequence 220, is applied to the second side encoder 206. It should be noted that the second side encoder 206, similar to the first side encoder 202, may also be advantageously embodied as any conventional predictive codec (e.g., MPEG-1/2/4, H.26-1/3). The even frame sub-sequence 220 is encoded by the second side encoder 206 which outputs encoded even frame sub-sequence 212. The encoded even frame sub-sequence 212 is included as one component to be output in the second data sub-stream 255. The encoded even frame sub-sequence 212 is also supplied as an input to central encoder sub-module 232, to be described below.

C. Central Encoder 204

Full frame sequence 201 is applied to the central encoder 204.

Central encoder sub-module 250 computes a first set of motion vectors 214 and also computes and encodes the even frame prediction sequence 215, which constitutes the prediction of even frames from the odd frames of input sequence 201. The central encoder sub-module 250 outputs the even frame prediction sequence 215 and the first motion vector sequence 214, both of which are supplied as input to central encoder sub-module 230.

Central encoder sub-module 260 computes a second set of motion vectors 216 and also computes and encodes the odd frame prediction sequence 217, which constitutes the prediction of odd frames from the even frames of input sequence 201. The central encoder sub-module 250 outputs the odd frame prediction sequence 217 and the second motion vector sequence 216, both of which are supplied as input to central encoder sub-module 230.

Central encoder sub-module 230 performs two functions or processes. A first process is directed to encoding the first set of motion vectors 214 received from sub-module 250 to output a first set of encoded motion vectors 218. The second function or process is directed to computing a first prediction residual 221, which may be computed as:
First Prediction residual=e_{c}−eₛ (1),
where e_{c}=even frame prediction frame sequence 215, and

eₛ=encoded odd frame sub-sequence 211.

The central encoder sub-module 230 output includes the encoded first prediction residual 221 along with the first set of coded motion vectors 218. These outputs are combined with the encoded odd frame sequence 211 (Point A) and collectively output as the first data sub-stream 245.

Similarly, the second prediction residual is computed for inclusion in the second data sub-stream 255 as follows:
Second Prediction residual=e_{c}−eₛ (2),
Where e_{c}=odd frame prediction frame sequence 217, and

eₛ=encoded even frame sub-sequence 212, and

The central encoder sub-module 232 output includes the encoded second prediction residual 222 along with the second set of coded motion vectors 219. These outputs are combined with the encoded even frame sequence 212 (Point B) and output as the second data sub-stream 255.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. An encoding method for encoding an input frame sequence (201), said method comprising the steps of:
a) encoding a first sub-sequence of frames (210) from said input frame sequence (201) to produce an encoded first sub-sequence of frames (211);
b) encoding a second sub-sequence of frames (220) from said input frame sequence (201) to produce an encoded second sub-sequence of frames (212);
c) computing a first predicted frame sequence (215) from said second sub-sequence of frames (220);
d) computing a second predicted frame sequence (217) from said first sub-sequence of frames (210);
e) computing a first set of motion vectors (214) from said first predicted frame sequence (215);
f) computing a second set of motion vectors (216) from said second predicted frame sequence (217);
g) computing a first prediction residual as an error difference between said first predicted frame sequence (215) and said encoded first sub-sequence of frames (211);
h) computing a second prediction residual as an error difference between said second predicted frame sequence (217) and said encoded second sub-sequence of frames (212);
i) encoding said first prediction residual, second prediction residual, said first set of motion vectors (214) and said second set of motion vectors (216);
j) determining a network condition;
k) scalably combining said encoded first prediction residual (218), said encoded first set of motion vectors (221) and said encoded first sub-sequence of frames (211) as a first data sub-stream (245) in accordance with said determined network condition;
l) scalably combining said encoded second prediction residual (219), said encoded second set of motion vectors (222) and said encoded second sub-sequence of frames (212) as a second data sub-stream (255) in accordance with said determined network condition; and
m) independently transmitting said first and second data sub-streams (245, 255).

2. The method of claim 1, wherein said determined network condition is a channel bandwidth determination.

3. The method of claim 1, including a preliminary step of arranging said input frame sequence (201) in a predetermined coding order, prior to said step (a).

4. The method of claim 1, wherein said first sub-sequence of frames (210) comprises only odd frames from said input frame sequence (201).

5. The method of claim 1, wherein said second sub-sequence of frames (220) comprises only those even frames from said input frame sequence (201).

6. The method of claim 1, wherein said second sub-sequence of frames (220) includes those frames from said input frame sequence (201) not included in said first sub-sequence of frames (210).

7. The method of claim 1, wherein said first and second sub-sequence of frames (210, 220) are selected in accordance with a user preference.

8. The method of claim 1, wherein said input frame sequence includes intraframes (I), predictive frames (P) and bi-directional frames (B).

9. An encoder 200 for encoding an input sequence of frames (201), said encoder (200) comprising:
a) encoding a first sub-sequence of frames (210) from said input frame sequence (201) in a first side encoder (202);
b) encoding a second sub-sequence of frames (220) from said input frame sequence (201) in a second side encoder (206);
c) computing a first predicted frame sequence (215) from said second sub-sequence of frames (220) in a central encoder (204);
d) computing a second predicted frame sequence (217) from said first sub-sequence of frames (210) in said central encoder (204);
e) computing a first set of motion vectors (214) from said first predicted frame sequence (215) in said central encoder (204);
f) computing a second set of motion vectors (216) from said second predicted frame sequence (217) in said central encoder (204);
g) computing a first prediction residual as an error difference between said first predicted frame sequence (215) and said encoded first sub-sequence of frames (211) in said central encoder (204);
h) computing a second prediction residual as an error difference between said second predicted frame sequence (217) and said encoded second sub-sequence of frames (212) in said central encoder (204);
i) encoding said first prediction residual, second prediction residual, first set of motion vectors (214) and second set of motion vectors (216) in said central encoder (204);
j) determining a network condition;
k) scalably combining said encoded first prediction residual (218), said encoded first set of motion vectors (221) and said encoded first sub-sequence of frames (211) as a first data sub-stream (245) in accordance with said determined network condition;
l) scalably combining said encoded second prediction residual (219), said second set of motion vectors (22) and said encoded second sub-sequence of frames (212) as a second data sub-stream (255) in accordance with said determined network condition; and
m) independently transmitting said first and second data sub-streams (245, 255) from said encoder (200).

10. The encoder of claim 9, wherein said first side encoder (202), said second side encoder (206) and said central encoder (204) are conventional predictive encoders.

11. The encoder 200 of claim 10, wherein said first side encoder (202), said second side encoder (206) and said central encoder (204) are scalable encoders.

12. The encoder of claim 10, wherein said conventional predictive encoders are encoders selected from the group of encoders including MPEG1, MPEG2, MPEG4, MPEG7, H.261, H.262, H.263, H.263+, H.263++, H.26L, and H.26L encoders.

13. The encoder of claim 9, wherein the encoder (200) is included within a telecommunication transmitter of a wireless network.

14. A system for encoding an input sequence of frames (201), the system comprising:
means for encoding a first sub-sequence of frames (210) from said input frame sequence (201) to produce an encoded first sub-sequence of frames (211);
means for encoding a second sub-sequence of frames (220) from said input frame sequence (201) to produce an encoded second sub-sequence of frames (212);
means for computing a first predicted frame sequence (215) from said second sub-sequence of frames (220);
means for computing a second predicted frame sequence (217) from said first sub-sequence of frames (210);
means for computing a first set of motion vectors (214) from said first predicted frame sequence (215);
means for computing a second set of motion vectors (216) from said second predicted frame sequence (217);
means for computing a first prediction residual as an error difference between said first predicted frame sequence (215) and said encoded first sub-sequence of frames (211);
means for computing a second prediction residual as an error difference between said second predicted frame sequence (217) and said encoded second sub-sequence of frames (212);
means for encoding said first prediction residual, second prediction residual, said first set of motion vectors (214) and said second set of motion vectors (216);
means for determining a network condition;
means for scalably combining said encoded first prediction residual (218), said encoded first set of motion vectors (221) and said encoded first sub-sequence of frames (211) as a first data sub-stream (245) in accordance with said determined network condition;
means for scalably combining said encoded second prediction residual (219), said encoded second set of motion vectors (222) and said encoded second sub-sequence of frames (212) as a second data sub-stream (255) in accordance with said determined network condition; and
means for independently transmitting said first and second data sub-streams (245, 255).

15. The system of claim 15, further including means for arranging said input frame sequence (201) in a predetermined coding order.
